(19) United States
(12) Patent Application Publication
(10) Pub. No.: US 2013/0279856 A1
(43) Pub. Date: Oct. 24, 2013

(54) SYSTEMS AND APPARATUSES FOR PROVIDING CONVERSION FROM A FIRST OPTICAL CONNECTOR TO MULTIPLE SECOND OPTICAL CONNECTORS

(71) Applicants: Mark E. Boduch, Geneva, IL (US); Yajun Wang, Naperville, IL (US); Thomas J. Huber, Naperville, IL (US)

(72) Inventors: Mark E. Boduch, Geneva, IL (US); Yajun Wang, Naperville, IL (US); Thomas J. Huber, Naperville, IL (US)

(73) Assignee: TELLABS OPERATIONS, INC., Naperville, IL (US)

(21) Appl. No.: 13/453,261

(22) Filed: Apr. 23, 2012

(51) Int. Cl. G02B 6/38

(52) U.S. Cl. 385/59

(57) ABSTRACT

An optical connector system having a first optical connector, a plurality of second optical connectors, and a mounting system hosting the first optical connector and the second optical connectors. The mounting system can be formed integrally with at least one pluggable optical device. The system also has a mechanism arranged to connect the first optical connector to the second optical connectors. The system also includes at least one further pluggable optical device having at least one optical interface optically coupled to the first optical connector of the at least one pluggable optical device. In one example, the pluggable optical device is a CFP device, and the further pluggable optical device is a QSFP+. With this configuration, the QSFP+ can accommodate at least one of a 40 G and 10 G interface capability. Also provided is a connector system and an apparatus (e.g., pluggable optical device) that enable such a capability.

### BACKGROUND

1. Field

Example aspects described herein relate generally to communications equipment, and more specifically to systems and apparatuses that enable a pluggable optical device to accommodate multiple communication interface types.

2. Description Of The Related Art

In today's high-technology world, data needs to be transmitted over high-speed computer networks. Optical fibers serve as good network data carriers because, in addition to being flexible and enabling signals to travel with little attenuation, they can each transmit data at a rate of at least ten gigabits (10 G) per second, often at least 40 G per second.

Signals that are communicated using optical fibers are often sent and received by pluggable optical devices. One known type of pluggable optical device is a C form-factor pluggable (CFP), which is multi-source and hot-pluggable. Another known type of pluggable optical device is a quad small form-factor pluggable plus (QSFP+), which is similar to a CFP but more compact.

Generally, pluggable optical devices of the QSFP+ type support a 40 G interface, but do not have sufficient surface area to be able to accommodate a plurality of 10 G interfaces, owing to the amount of area that would be required for the associated LC optical connectors and patch panels to accommodate such interfaces. Also, even if a break-out cable (which has been used in the prior art to support 10 G client equipment) were to be connected to the 40 G interface of a QSFP+, and 10 G fibers of the break-out cable were to be connected to 10 G client equipment externally from the QSFP+, such a configuration can suffer from fiber length mis-match issues.

### SUMMARY

The above and other limitations are overcome by an optical system that enables at least one pluggable optical device to accommodate at least one additional type of interface capability, and also by a connector system usable in the system, and the at least one pluggable optical device.

In one example embodiment herein, the optical connector system comprises a first optical connector, a plurality of second optical connectors, and a mounting system hosting at least the plurality of second optical connectors. The connector system also includes a mechanism arranged to connect the first optical connector to the plurality of second optical connectors. In one example embodiment, the mounting system is formed integrally with the at least one pluggable optical device.

The system also can include at least one further pluggable optical device having at least one optical interface optically coupled to the first optical connector.

In one example embodiment, the pluggable optical device is a CFP device, and the further pluggable optical device is a QSFP+. With this configuration, the QSFP+ can accommodate at least one of a 40 G and 10 G interface capability, thereby enabling the QSFP+ to be connectable to at least one of 40 G and 10 G client equipment.

By virtue of the above system, small form-factor pluggable (SFP+) cages and associated crosspoint are not necessary, thereby enabling costs to be reduced, and also rendering it possible to support both transponder and muxponder applications.

### BRIEF DESCRIPTION OF THE DRAWINGS

The teachings claimed and/or described are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows an optical circuit pack according to an example embodiment herein.

FIG. 2 shows a pluggable optical device according to an example embodiment herein, which in one example can form device 105 of FIG. 1.

FIG. 3 shows a pluggable optical device according to another example embodiment herein, which according to another example can form the device 105 of FIG. 1.

FIG. 4 shows a pluggable optical device according to a further example embodiment herein, which in still a further example, can form device 105 of FIG. 1.

FIG. 5 shows an example of an optical circuit pack having an integral patch panel, according to a further example embodiment herein, as viewed from a perspective looking down on to the patch panel.

FIG. 6 shows an example of a front panel of an optical circuit pack having a blank plate, according to a further example embodiment herein, as viewed from a perspective looking down on the front panel.

FIG. 7 shows the front panel of FIG. 6, with the blank plate removed.

FIG. 8a shows a blank plate of the front panel of FIG. 6, as viewed from a perspective looking down at the plate.

FIG. 8b shows the plate of FIG. 8a, as viewed from a perspective looking at a side thereof.

FIG. 9 shows a patch panel plate having connectors interconnected via optical cables, as viewed from a perspective looking towards a side thereof, according to a further example embodiment herein.

FIG. 10 shows an example of a front panel of an optical circuit pack with a patch panel plate, such as the patch panel plate of FIG. 9, according to a further example embodiment herein, as viewed from a perspective looking down on the front panel.

FIG. 11 shows an optical circuit pack with a patch panel residing on a removable plate, and a pluggable optical device according to an example embodiment herein.

It should be noted that different ones of the Figures may include the same reference numerals to identify the same components, and thus a description of each such component may not be provided herein with respect to each particular Figure.

### DETAILED DESCRIPTION

The present application presents several novel and inventive approaches for combining the capabilities of multiple pluggable optical devices, such as optical transceivers, to enable at least one of them to accommodate at least one functional capability that it would not otherwise be able to accommodate.

As described above, generally it is difficult, if not impossible, to make pluggable optical devices of the small form-factor pluggable plus (QSFP+) type accommodate a plurality of 10 G interfaces, owing to the amount of space that would be required for the associated connectors. Thus, such QSFP+ devices generally do not operate with direct 10 G-capable connections that would be used to connect to, for example, external client equipment. However, according to an example aspect herein, a configuration is provided that enables a pluggable optical device, such as a QSFP+ optical device, to operate with such a capability.

By example only, one example embodiment herein enables a pluggable optical device, such as a QSFP+ optical device, to support at least one additional type of communication interface. More particularly, in one example embodiment a QSFP+ optical device that has the ability to support a 40 G interface, is provided with a capability to support 10 G interfaces, although the scope of the invention is not limited to either of those particular types of interfaces only. Such a QSFP+ optical device can thus be connected to at least one of 40 G and 10 G client equipment.

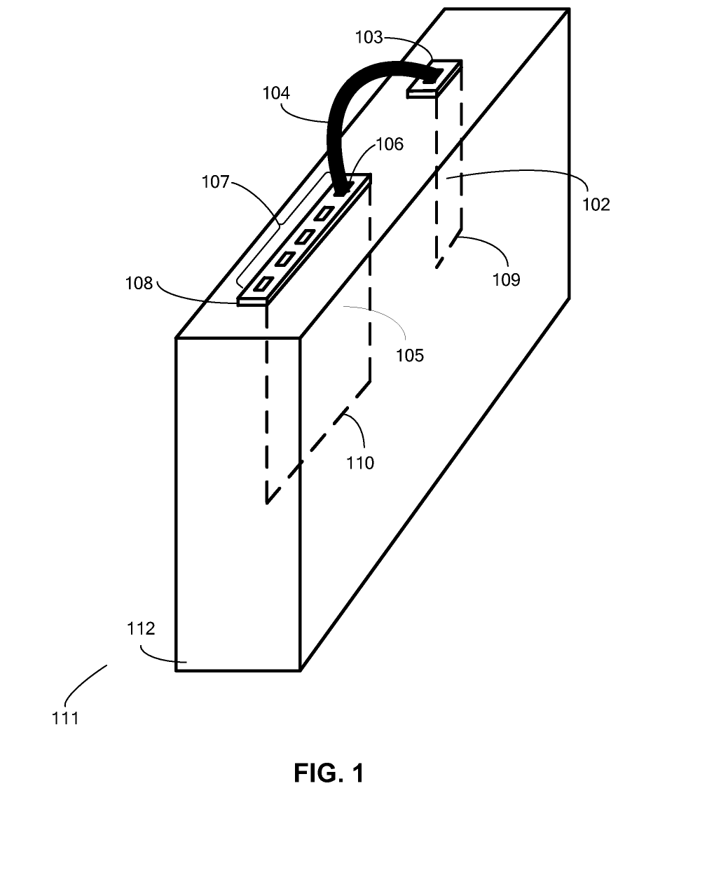

FIG. 1 shows an optical circuit pack 111 according to an example embodiment herein. The circuit pack 111 has a housing 112 in which a plurality of pluggable optical devices, such as a pluggable optical device 102 and a pluggable optical device 105 shown in the illustrated example, are provided. In one example embodiment, the pluggable optical device 102 is a QSFP+ optical device and the pluggable optical device 105 is a CFP optical device. For convenience, pluggable optical device 102 will be referred to hereinafter as a QSFP+ 102, and pluggable optical device 105 will be referred to hereinafter as a CFP 105, although it should be understood that the number and types of pluggable optical devices shown in the drawings and referred to herein are for purposes of illustration only, and that the scope of the invention should not be construed as being limited only thereto.

A communication port (e.g., a QSFP+ port) 109 is provided in the housing for QSFP+ 102, and a CFP communication port 110 is provided in the housing for CFP 105. In one example embodiment these ports each can include a mechanical cage structure, for mechanical support. The QSFP+ 102 has a communication interface (also referred to herein as an optical connector) 103, such as, for example, a 40 G interface. In one example embodiment, the CFP 105 has an integrated patch panel 108 hosting a communication interface (also referred to herein as an optical connector) 106 as well as communication interfaces (also referred to herein as optical connectors) 107. In one example embodiment, interface 106 is a 40 G interface, and interfaces 107 include four 10 G interfaces. In this context, it is understood that a 10 G interface can support data rates from 9.9 Gbps to 11.5 Gbps, and a 40 G interface can support rates from 39 Gbps to 46 Gbps. A cable 104, such as, in one example, a 40 G parallel fiber cable, is communicatively connected to the interface 103 at one end and to the interface 106 at another end, thus connecting the CFP 105 with the QSFP+ 102. It should be noted that, while the cable 104 is represented as being external to the circuit pack 111, in other embodiments it can be included within the housing 112 of the circuit pack 111.

According to an example aspect herein, the QSFP+ 102 can support interfaces, such as for example, 10 G interfaces, through the existing CFP port 110, without having to itself accommodate connectors for interfaces such as 10 G interfaces. In this manner, the circuit pack 111 can support both transponder applications with 10 G interfaces and applications with 40 G interfaces, as well as muxponder applications with the combination of the 10 G and 40 G interfaces on the QSFP+ 102 and CFP 105. For example, for “add direction” signals being added, the circuit pack 111 can be equipped to combine four 10 G signals into a single wavelength 40 G Wavelength Division Multiplexed (WDM) signal, and, for “drop direction” signals to be dropped, the circuit pack 111 can be equipped to de-multiplex four 10 G signals from a 40 G single wavelength WDM signal, although this example is non-limiting.

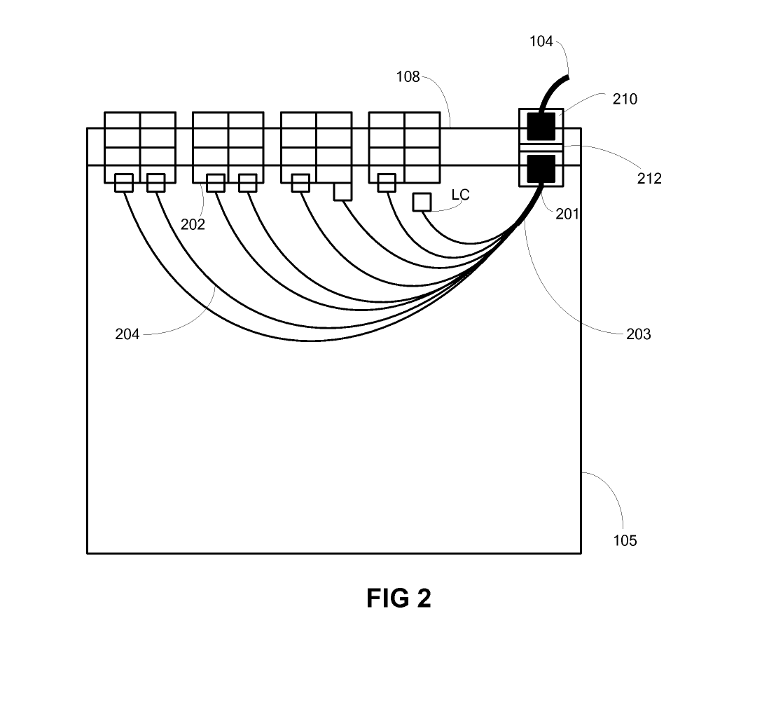

Referring now to FIG. 2, an example of one type of pluggable optical device that may form CFP 105 with an integrated patch panel 108 will now be described. A receptacle connector 212 (e.g., a bulkhead adaptor) is provided in the patch panel 108. Plugged into both sides of connector 212 are respectively two connectors 210 and 201, such as multi-fiber termination push-on (MTP) connectors. One or more of the components 201, 210, 212 may form, for example, at least part of the interface 106 of FIG. 1. Also provided in the patch panel 108 is at least one connector 202 (e.g., four are shown in FIG. 2) which may form, for example, the interfaces 107 of FIG. 1. In one example embodiment, each of the connectors 202 is a dual LC connector. Connector 210 is coupled to an end of cable 104, and connector 201 is coupled to an end of another cable 203 which, in one example embodiment, is a 40 G parallel fiber cable or a 40 G optical link.

The cable 203 can be broken out into individual optical fibers 204, which are respectively coupled to the connectors 202. In particular, in one example embodiment, each connector 202 is at 10 G connector that is connected to a corresponding pair of the individual optical fibers 204, and each individual fiber of the pair is a unidirectional fiber that carries signals traveling in a direction that is opposite to the direction in which signals are carried by the other one of the fibers of the pair, such that together the pair functions bidirectionally. Of course, the scope of the invention is not limited to that configuration only, and in other embodiments, for example, single bidirectional fibers or other configurations can be employed.

In this manner, the CFP 105 has an integrated patch panel 108 which hosts various connectors, including, for example, connectors 212 and 202 (and, in one example, that configuration enables individual optical fibers 204 to be employed that have fixed, uniform lengths). By virtue of that configuration, and by connecting the CFP 105 with the QSFP+ 102 through the cable 104 as described above in connection with FIG. 1, the CFP 105 can enable the QSFP+ 102 to support 10 G client equipment.

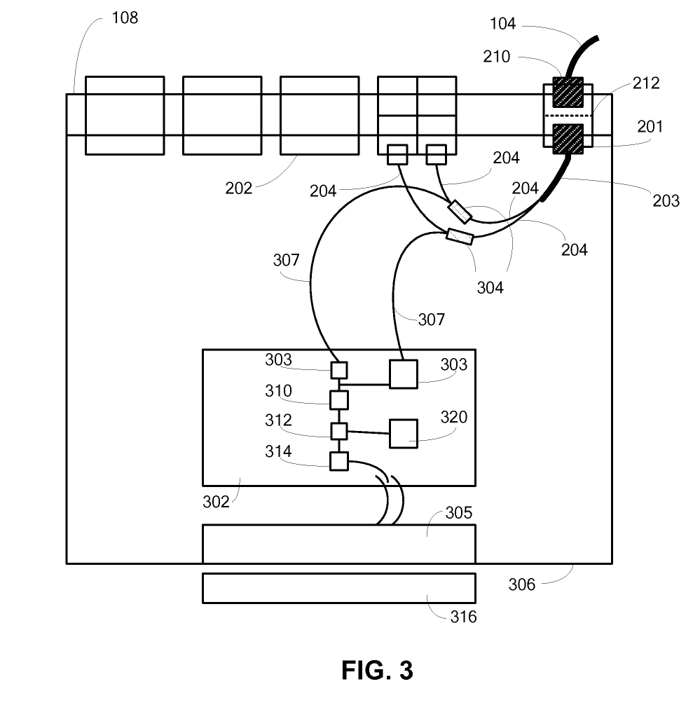

Another example embodiment of a pluggable optical device, such as a CFP 306, will now be described, with reference to FIG. 3. In one example embodiment, the CFP 306 can form the CFP 105 of FIG. 1. The CFP 306 of FIG. 3 is shown coupled to cable 104 through connector 210, and includes the same components 108, 201, 202, 203, 204 as in FIG. 2 described above. The CFP 306 is configured to enable signals to be monitored for ensuring that one or more components are operating correctly.

For example, in the illustrated embodiment, each communication path formed by a respective one of the fibers 204 has a coupling device 304, such as a 1:N optical coupler, interposed therein (e.g., N=2 in the illustrated embodiment). At each coupling device 304, an optical signal received by the device 304 from the respective fiber 204 is split, and provided on each of the N outputs of the device 304. One version of the signal is outputted through one output of the device 304 and is forwarded to a corresponding one of connectors 202 (e.g., in one example the signal is forwarded to one connector part of a dual LC connector). A further version of the signal is provided at another output of the device 304 and is forwarded along another communication path formed by a corresponding fiber 307 to a circuit device, such as a PCB assembly 302, provided in the CFP 306.

The further version of the signal provided at the other output of each device 304 is forwarded to a corresponding optical detector 303. Each detector 303 is responsive to a received signal by detecting whether the power level of the signal meets or exceeds a predetermined power level, meaning that a signal is present on the applicable communication path formed by the components 307, 304, 204, 203, 201, 210, 212, and 104. If the predetermined power level is not met or exceeded, then no signal is deemed present in the applicable communication path, which may indicate a need for troubleshooting.

The PCB assembly 302 has one or more electrical components. In one example embodiment, the assembly 302 includes the optical detectors 303, such as, for example, a photodiode detector. The printed circuit board (PCB) assembly 302 also can include additional components such as one or more optical-to-electrical converters (and/or electrical-to-optical converters) 310, controllers 312 (e.g., one or more microprocessors and/or field-programmable arrays), communication electronics 314, one or more memories 320, one or more amplifiers (not shown), and the like.

An electrical connector 305 provided in the CFP 306 also enables the PCB assembly 302 to be attached or coupled to a control device such as a motherboard assembly 316, and/or a network control system or element. In the illustrated embodiment, assembly 316 is shown external to the CFP 306 (in one example assembly 316 is included in a housing of an optical circuit pack in which CFP 306 is housed, although this example is non-limiting).

The PCB assembly 302 can exchange information with the assembly 316. For example, PCB assembly 302 can receive from the motherboard assembly 316 various commands for monitoring the activities of the CFP 306, and the assembly 302 can process the commands and return replies to the motherboard assembly 316.

One example of a type of command provided by the assembly 316 is a query for the power level in one or more communication paths monitored by corresponding ones of the photodetectors 303. An indication of the power level detected by the applicable photodetectors 303 is provided to the controller 312 by way of converter 310, and the controller 312 responds to the command from the assembly 316 by providing an indication of the power level to the assembly 316 by way of components 314 and 305.

Another type of command is a query for a type of the pluggable optical device, such as, for example, whether the applicable device is a CFP or QSFP+, and/or whether the device is a certain type of CFP or QSFP+, and/or whether the device has transceiver capabilities. For example, the memory 320 can include an internal register which stores information representing the type of the pluggable optical device in which it resides (e.g., information indicating that device 306 is a CFP), and/or the whether the device has transceiver capabilities. The information in the internal register can thus be retrieved by controller 312 in response to it receiving the query from the motherboard assembly 316, and then the controller 312 forwards the information to the assembly 316 by way of components 314 and 305.

It should be noted that, for convenience, only one of the connectors 202 is represented in FIG. 3 as being coupled to fibers 204, and only the optical couplers 304 and optical detectors 303 that are associated with that connector 202 are represented in FIG. 3 as well. However, one skilled in the art would clearly understand in view of this description that elements 204, 303, 304 also can be provided for one or more of the other connectors 202 as well. Also, although two photodiode detectors 303 are shown to correspond with an optical connector 202, in other example embodiments only a single detector, or other multiple detectors, are provided to detect signals for one or more fibers 307 connected to one or more connectors 202, in any applicable combination.

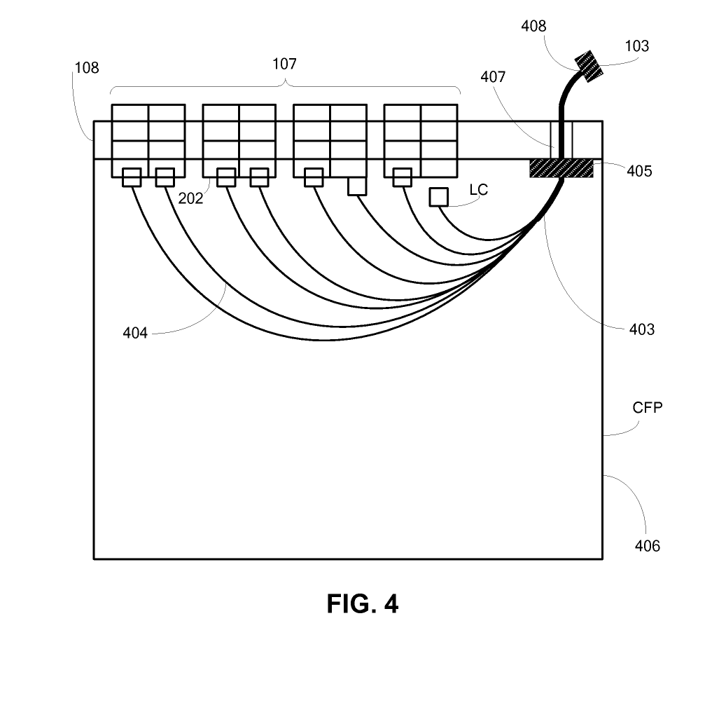

Another example of a pluggable optical device that may form the pluggable optical device 105 of FIG. 1 will now be described, with reference to FIG. 4. In FIG. 4 a CFP 406 includes similar components as those of FIG. 2 described above, except that instead of employing the components 104, 201, 203, 210, and 212, described above, an optical cable (e.g. a parallel fiber cable) 403 is provided through a gap 407 in the patch panel 108. The optical cable 403 is again broken out into individual optical fibers 404, which are connected at one end to connectors 202 in a similar manner as described above with respect to FIG. 2. An opposite end of the cable 403 can be directly connected to, for example, the interface 103 of the QSFP+ 102 (FIG. 1) by way of a connector (e.g., a MTP connector) 408. In one example embodiment, at least one mechanism 405, such as, for example, a plastic molded assembly or the like, is provided to secure the cable 403 to the patch panel 108.

According to an example aspect herein, by virtue of the configuration of FIG. 4, the CFP 406 does not need interface 106 of FIG. 1 (e.g., a 40 G interface), and can be directly connected with another pluggable optical device, such as the QSFP+ 102 of FIG. 1, thereby eliminating the cost and complexities associated with the interface 106 and components 201, 210, and 212, as well as the labor required for interconnecting them, and also increasing the reliability of the CFP 406 relative to the configuration of FIG. 2, for example. The CFP 406 also experiences less insertion loss without the connectors 201, 210 and 212 (e.g., a MTP connector may add 0.5 to 1 dB of optical insertion loss).

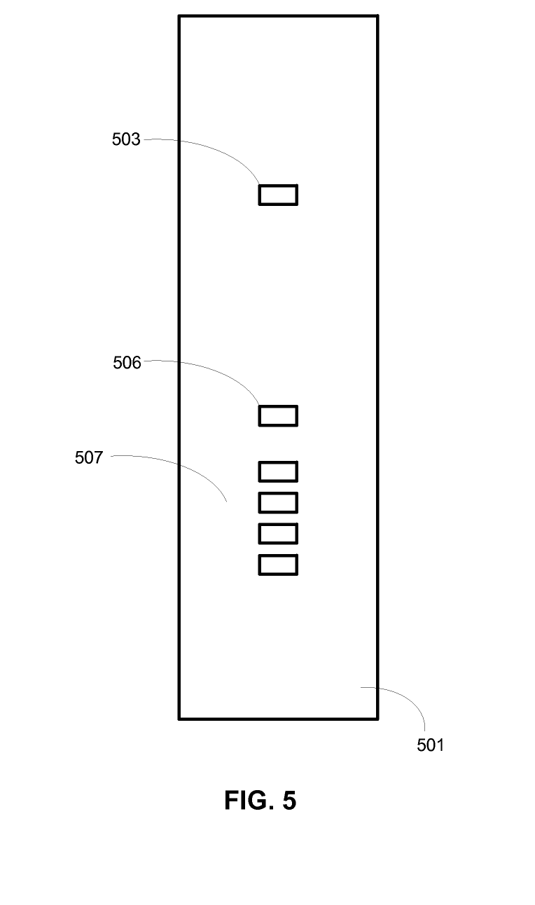

FIG. 5 shows an example of a front panel 501 of an optical circuit pack having an integrated patch panel including connectors 506 and 507, according to a further example embodiment herein, as viewed from a perspective looking down on to the front panel 501. The front panel 501 hosts communication interfaces, including an interface 503 (e.g., a 40 G interface), as well as communication interfaces, including interface 506 (e.g., a 40 G interface) and multiple interfaces 507 (e.g., 10 G interfaces). Although not shown in FIG. 5 for convenience, the interfaces 507, 506, and 503 can be formed by connectors and connected together by one or more cables/fibers and the like, in the same manner as described above for corresponding interfaces of FIGS. 1 to 4.

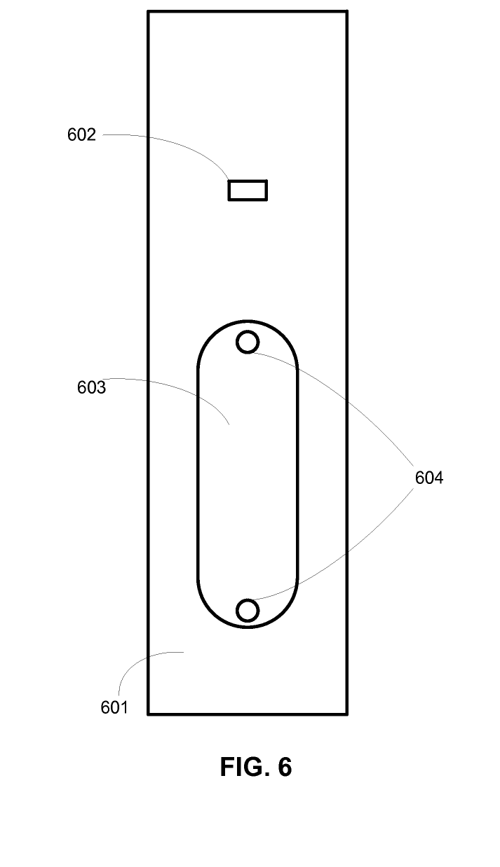

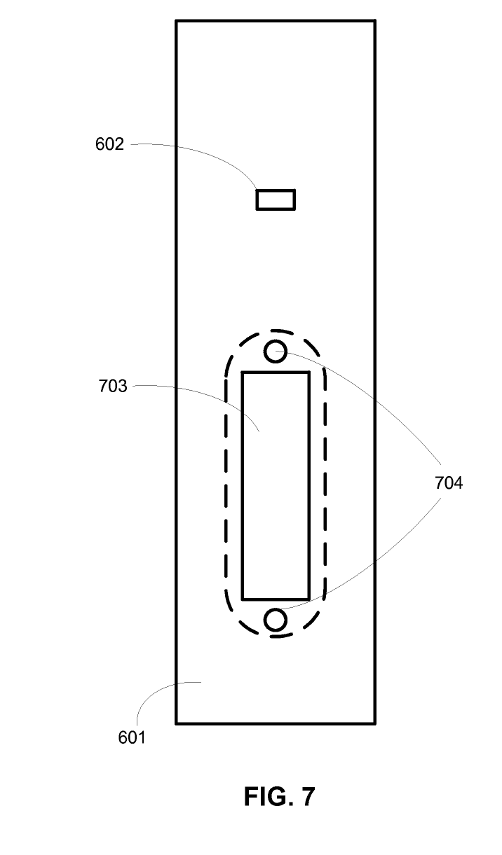

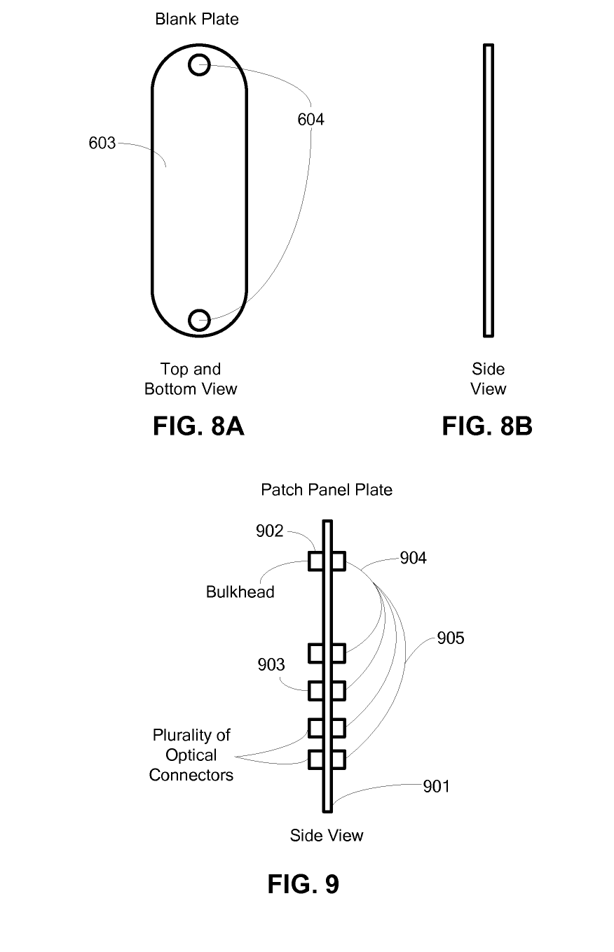

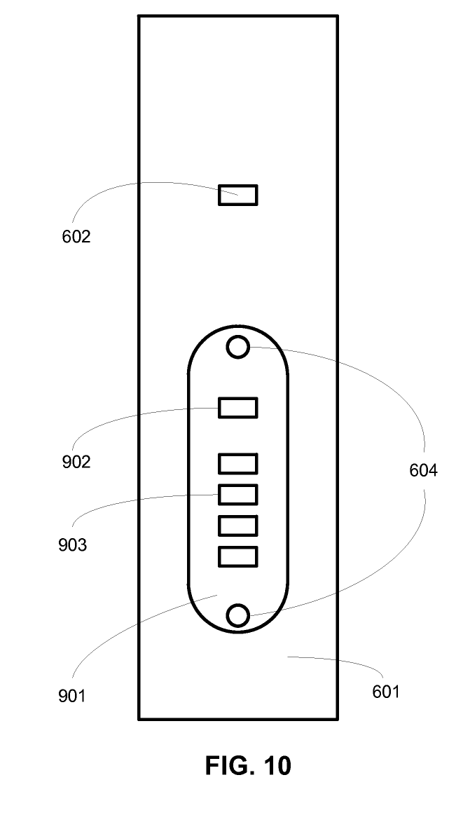

According to another example aspect herein, and referring now to FIGS. 6, 7, 8A, 8B, 9, and 10, a different configuration besides those provided by the above-described panels 108 and 501, is provided. FIGS. 6, 7, and 10 show a front panel 601 of an optical circuit pack, with an attached blank plate 603, as viewed from a perspective looking down on to the panel 601 and plate 603. The front panel 601 has an optical connector 602 formed therein (which connector is similar to the connector 503 of FIG. 5), and also has a space 703 (FIG. 7) formed therein that can be covered by the blank plate 603 (FIGS. 6, 8A, 8B). When the blank plate 603 covers the space 703, it can be removed and replaced with another plate, such as a plate 901 (FIG. 9), or be engineered into plate 901, having connectors 902, 903 mounted therein (FIGS. 9 and 10), and that plate 901 can be fastened (or attached) to part the patch panel 601 to thereby make it integral with the circuit pack (FIG. 10).

The blank plate 603 and the plate 901 with the patch panel assembly may be fastened (or attached) to the front panel 601 using two or more screws 604, or some similar acceptable attachment mechanism. In one embodiment, the plates 603 and 901 may contain integrated “captive screws”, preventing the need for screws that are separate entities. Such captive screws may have integrated “thumb screws” that allow the panel to be attached without the need for any type of tool, such as a screw driver or Allen wrench.

FIG. 9 represents the manner in which the connectors 902 and 903 are connected via a break-out cable 904 having plural individual optical fibers 905. In one example embodiment, the cable 904 and fibers 905 are not visible from a perspective looking down on plate 901, when plate 901 is positioned in the front panel 601 as shown in FIG. 10.

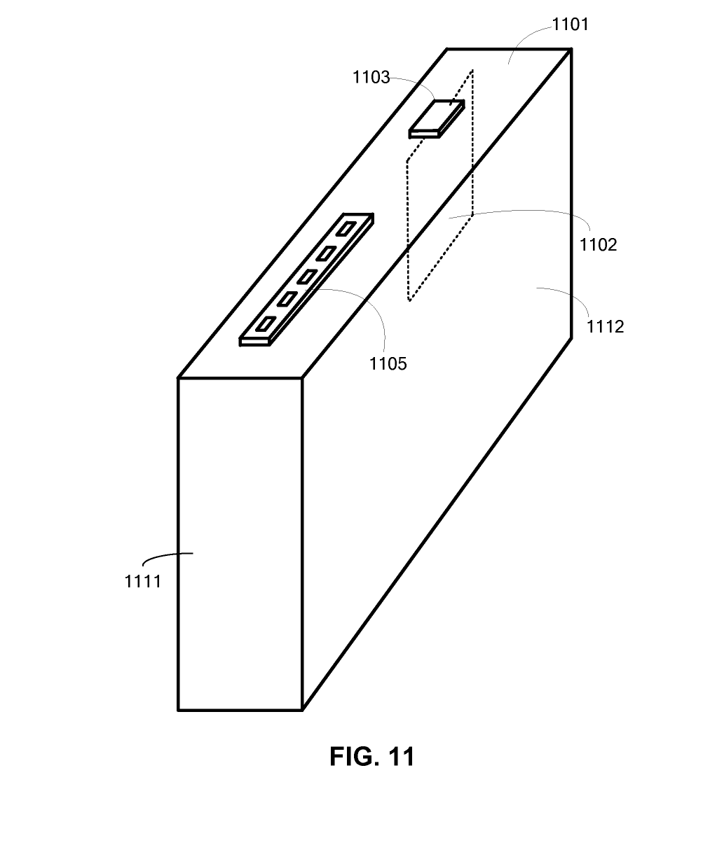

Referring now also to FIG. 11 in conjunction with FIGS. 6-10, although the optical connector 602 of FIG. 6 can be directly mounted on the front panel 601, in an alternative embodiment an optical connector 1103 can be formed on a pluggable optical device (such as a QSFP+) 1102 that plugs into a front panel 1101 of an optical circuit pack (e.g., the optical device 1102 including connector 1103 fits into a hole in front panel 1101). For this embodiment, the front panel 1101 can be equipped with a hole for the pluggable optical device and plate 1105, and, in one example, the plate 1105 can be, for example, a blank plate such as plate 603 represented in FIG. 6, or a plate (in the case shown in FIG. 11) such as plate 903 with a patch panel assembly as represented in FIG. 10 (and having similar interconnecting cable/fiber configurations). Plate 1105 can be connected or otherwise attached to another pluggable optical device, such as, for example, a QSFP+ or a CFP, in a similar manner as described for the above embodiments.

It should be noted that, according to one embodiment herein, a circuit pack is provided with a patch panel integrated into the circuit pack's front panel (like that shown in FIG. 5, including connectors 506 and 507), and a pluggable optical device containing an optical connector (like that shown in FIG. 11, consisting of elements 1102 and 1103). This embodiment is a combination of the circuit pack of FIG. 5 and the circuit pack of FIG. 11, wherein the front panel has a hole for a pluggable optical device like shown in FIG. 11, and an integrated patch panel like that shown in FIG. 5. For this embodiment, the integrated connector 503 in FIG. 5 is replaced with the pluggable optical device 1102 containing the like connector 1103.

It should be noted that, although not shown in the drawings besides FIG. 3 for convenience, the CFP and/or QSFP+ of any of the other drawings also can include optical couplers, optical detectors, PCB assemblies, electrical connectors, optical-to-electrical converters (and/or electrical-to-optical converters), controllers, motherboard assemblies, communication electronics, memories, amplifiers, and the like, as discussed above with respect to FIG. 3. Also, it should be understood that the number and type(s) of pluggable optical devices shown in the drawings and referred to herein are for purposes of illustration only, and that the scope of the invention should not be construed as being limited only thereto.

The above example embodiments enable a pluggable optical device, such as a QSFP+ that has at least one 40 G interface for connecting to 40 G client equipment, to support at least one additional type of communication interface (e.g., 10 G interfaces), thereby enabling the QSFP+ to be connectable to 10 G client equipment. As a result, it is possible to support both transponder and muxponder applications using, for example, a same circuit board.

Of course, it also is within the scope of the present invention to enable one or more pluggable optical devices to accommodate more than the types of communication interfaces mentioned herein, and interfaces 103, 106, 107, 1103, 1106, 1107 may include more (or less, in the case of interfaces 107 and 1107) than the number of connectors referred to herein, and those interfaces may have other bandwidth capabilities besides 40 G and/or 10 G referred to herein. In one example embodiment, the number of connectors 202 can be another multiple of the number of interface(s) 103, 1103, besides four, or need not be any particular multiple of that number of interface(s). Also, although described in the context of pluggable optical devices, the scope of the invention is not limited only thereto, and also can encompass providing multiple interface-type accommodation for other types of devices besides pluggable optical devices.

In the above descriptions, various aspects of the invention have been described with reference to specific example embodiments. The specification and drawings are accordingly to be regarded in an illustrative rather than in a restrictive sense. It will, however, be evident that various modifications and changes may be made without departing from the broader spirit and scope of the present invention.

In addition, it should be understood that the figures illustrated in the attachments, which highlight the functionality and advantages of the present invention, are presented for example purposes only. The architecture of the example aspect of the present invention is sufficiently flexible and configurable such that it may be utilized (and navigated) in ways other than that shown in the accompanying figures.

Although example aspects of this invention have been described in certain specific embodiments, many additional modifications and variations would be apparent to those skilled in the art. It is therefore to be understood that this invention may be practiced otherwise than as specifically described. Thus, the present example embodiments, again, should be considered in all respects as illustrative and not restrictive.

What is claimed:

1. An optical connector system for an optical circuit pack,
comprising: a first optical connector;
a plurality of second optical connectors;
a mounting system for at least one pluggable optical device, the mounting system hosting at least the plurality of second optical connectors; and
a mechanism for connecting the first optical connector to the plurality of second optical connectors.

2. The optical connector system of claim 1, wherein the mounting system is formed integrally with the at least one pluggable optical device.

3. The optical connector system of claim 1, wherein the mechanism includes at least one optical cable.

4. The optical connector system of claim 1, wherein the at least one pluggable optical device is a C form-factor pluggable (CFP) optical device.

5. The optical connector system of claim 1, wherein at least one of the plurality of second optical connectors includes a LC optical connector.

6. The optical connector system of claim 1, wherein the first optical connector includes a parallel optical connector.

7. The optical connector system of claim 1, wherein the first optical connector includes at least one MTP parallel optical connector.

8. The optical connector system of claim 1, wherein the mechanism includes a plurality of optical fibers.

9. The optical connector system of claim 8, wherein each of the second optical connectors is coupled to ends of respective pairs of the plurality of optical fibers.

10. The optical connector system of claim 9, wherein the first optical connector is coupled to further ends of the plurality of optical fibers.

11. The optical connector system of claim 1, wherein the at least one pluggable optical device has the second plurality of optical connectors, and a further at least one pluggable optical device has the first optical connector.

12. The optical connector system of claim 1, wherein the first optical connector supports a 40 Gbps signal rate and at least one of the second optical connectors supports a 10 Gbps signal rate.

13. The optical connector system of claim 11, wherein the at least one pluggable optical device is a C form-factor pluggable (CFP) optical device, and the at least one further pluggable optical device is a quad small form-factor pluggable plus (QSFP+) optical device.

14. The optical connector system of claim 11, further comprising a further optical connector included in the at least one pluggable optical device, the first optical connector being coupled to the plurality of second optical connectors by way of the further optical connector.

15. The optical connector system of claim 14, wherein the further optical connector includes at least one MTP connector.

16. The optical connector system of claim 1, wherein the at least one pluggable optical device includes at least one controller.

17. The optical connector system of claim 16, wherein the controller is arranged to be communication with a motherboard assembly.

18. The optical connector system of claim 1, wherein the at least one pluggable optical device further comprises at least one optical detector arranged to detect presence of an optical signal in the mechanism.

19. The optical connector system of claim 17, wherein the controller communicates an indication of the presence of an optical signal to the motherboard assembly.

20. The optical connector system of claim 17, wherein the controller communicates an indication of a type of the pluggable optical device to the motherboard assembly.

21. The optical connector system of claim 1, wherein the mounting system includes a plate.

22. An optical system, comprising:
at least one pluggable optical device including:
a first optical connector,
a plurality of second optical connectors,
a mounting system hosting the first optical connector and the plurality of second optical connectors, and
a mechanism arranged to connect the first optical connector to the plurality of second optical connectors.

23. The optical system of claim 22, further comprising at least one further pluggable optical device having at least one optical interface optically coupled to the first optical connector of the at least one pluggable optical device.

24. The optical system of claim 23, further comprising at least one optical cable through which the at least one optical interface of the at least one further pluggable optical device is optically coupled to the first optical connector of the at least one pluggable optical device.

25. The optical system of claim 23, wherein the at least one pluggable optical device is a C form-factor pluggable (CFP) device, and the at least one further pluggable optical device is a quad small form-factor pluggable plus (QSFP+) device.
